(19) United States
(12) Patent Application Publication
(10) Pub. No.: US 2023/0417103 A1
(43) Pub. Date: Dec. 28, 2023

(54) Blind, a glazing system for a terrace or a balcony, and a method for arranging a blind in connection with a glazing system for a terrace or a balcony

(71) Applicant: Suomen Visor Oy, Kempele (FI)

(72) Inventors: Markku PULKKINEN, Tupos (FI); Teuvo HAAPALAHTI, Oulunsalo (FI); Tuukka LIUKKO, Ii (FI); Timo KOTAJÄRVI, Oulu (FI)

(21) Appl. No.: 18/340,149

(22) Filed: Jun. 23, 2023

(30) Foreign Application Priority Data
Jun. 23, 2022 (FI) 20225578

(51) Int. Cl. E06B 9/262; E06B 3/46; E06B 9/323; E06B 9/60; E06B 9/72

(52) U.S. Cl. CPC E06B 9/262; E06B 3/4609; E06B 9/323; E06B 9/60; E06B 9/72; E06B 2009/2625

(57) ABSTRACT

A blind comprises an edge strip, at least two guide cords connected at their first end to the edge strip, and a screen whose first edge is provided with a first edge profile and whose second edge is provided with a second edge profile, wherein the guide cords extend through the edge profiles. The blind further comprises lifting means for coiling, uncoiling, and storing the coiled guide cord, the second ends of the guide cords being fastened to the lifting means. A terrace or balcony glazing system comprises a frame with an upper guide track and a lower guide track as well as glazing elements, wherein at least some of the glazing elements are movable along the upper guide track and the lower guide track. The glazing system also comprises at least one above-described blind which is fastened to the frame of the glazing system, separately from the glazing elements.

A blind, a glazing system for a terrace or a balcony, and a method for arranging a blind in connection with a glazing system for a terrace or a balcony

### PRIORITY

This application claims priority to Finnish national application 20225578, filed on 23 Jun. 2022, the contents of which is incorporated herein by reference.

### FIELD OF THE INVENTION

The invention relates to a blind comprising an edge strip, at least two guide cords connected at their first end to the edge strip, a screen which is movable along the guide cords and whose first edge is provided with a first edge profile and whose second edge is provided with a second edge profile, the guide cords extending through the edge profiles, and the first and second edge profiles being suspended on the guide cords and being movable independently of each other. The invention also relates to a glazing system for a terrace or a balcony, provided with a blind according to the invention, and a method for arranging a blind in connection with a glazing system for a terrace or a balcony.

### BACKGROUND OF THE INVENTION

Balconies and terraces are often equipped with glazing systems to improve the conditions and convenience of their use. The glazing systems are normally made of movable glazing elements which can be transferred along guide tracks to a use position, to border the balcony or terrace to be shielded. If necessary, the glazing elements can be transferred along the guide tracks to a storage position in which the glazing elements are stacked side by side, wherein they restrict the use of the balcony or terrace very little. Particularly glazing systems for terraces are typically provided with guide tracks equipped with three or five sliding grooves so that adjacent glazing elements arranged in different sliding grooves can slide past each other and overlap each other.

On glazed balconies and terraces, blinds are often used to block excessive solar radiation and to limit visibility to the balcony or terrace. The blinds are often fastened to a single glazing element of the glazing system so that they are movable along with the glazing element. Blinds of prior art normally comprise two edge strips, at least two guide cords extending from the first edge strip to the second strip, and a movable screen suspended on the guide cords. The screen may be a blind pleated in a zigzag shape and made of rigid fabric. The first edge strip is fastened to the edge profile at the top edge of the glazing element, and the second edge strip is fastened to the edge profile at the bottom edge of the glazing element. The fastening of the edge strips can be implemented by separate fastening means or by fasteners integrated in the edge strip. Some blinds of prior art are presented in publications EP 3862527 A1 and EP 3530868 A1.

A blind fastened to the glazing element increases the overall thickness of the glazing element equipped with sunshades. Increasing the overall thickness is problematic particularly in terrace glazing systems in which the glazing elements should have sufficient space to overlap each other and to slide past each other. The development of balcony and terrace glazing systems seems to lead to the use of narrower and narrower edge profiles for glazing elements, which hampers the installation of solar blinds in them.

The aim of the invention is to present a blind, a terrace or balcony glazing system, and a method for fastening a blind to a glazing system, whereby drawbacks related to the state of the art can be eliminated.

The objects of the invention are obtained with a blind, a terrace or balcony glazing system, and a method, which are characterized in what is presented in the independent claims. Some advantageous embodiments of the invention are presented in the dependent claims.

### BRIEF SUMMARY OF THE INVENTION

The blind according to the invention comprises an edge strip, at least two guide cords whose first ends are attached to the edge strip, and a screen movable along the guide cords, wherein the first edge of the screen is equipped with a first edge profile and the second edge of the screen is equipped with a second edge profile, wherein the guide cords extend through the edge profiles, and wherein the first and second edge profiles are movable irrespective of each other and are suspended on the guide cords. The blind further comprises lifting means for coiling, uncoiling, and storing the coiled guide cord, the second ends of the guide cords being fastened to the lifting means.

In a preferred embodiment of the blind according to the invention, said screen is a pleatable fabric; in other words, the blind is a so-called pleated blind.

In another preferred embodiment of the blind according to the invention, said lifting means comprise a tube which is rotatable around its longitudinal axis and to which tube the second ends of said guide cords are fastened, directly or indirectly. Preferably, string cones are provided around said tube, wherein said guide cords are arranged to coil around said string cones when the tube is rotated.

Yet another preferred embodiment of the blind according to the invention comprises an actuator for rotating the tube. Said actuator comprises a spring element for storing energy to be applied for rotating the tube. Alternatively, said actuator may comprise an electric motor. A chargeable battery may be arranged in connection with the electric motor.

In yet another preferred embodiment of the blind according to the invention, said actuator is arranged at least partly inside the tube.

Yet another embodiment of the blind according to the invention comprises an elongate housing in which said lifting means are arranged. Preferably, said housing comprises a first end piece and a second end piece, wherein said end pieces comprise openings facing the housing, and said guide cords are arranged to extend via the opening in the first or the second end piece.

In yet another preferred embodiment of the blind according to the invention, end plugs are provided at the ends of the first and second edge profiles, wherein the end plugs comprise a hole opening to the inside of the edge profile, and said guide cords are arranged to extend via the hole in the end plug of the first edge profile and via the hole in the end plug of the second edge profile.

In yet another preferred embodiment of the blind according to the invention, edge plugs are provided at the ends of the first edge strip, wherein the edge plugs comprise a hole opening to the inside of the edge strip, and said guide cords are arranged to extend via the hole in the edge plug.

In yet another preferred embodiment of the blind according to the invention, said edge strip comprises an engaging part for fastening the edge strip in a removable way to the frame of the terrace or balcony glazing system.

The terrace or balcony glazing system according to the invention comprises a frame with an upper guide track and a lower guide track as well as glazing elements, wherein at least some of the glazing elements are movable along the upper guide track and the lower guide track. Moreover, the terrace or balcony glazing system comprises at least one blind of the above described type, wherein the blind is fastened to the frame of the glazing system, separately from the glazing elements. Preferably, the housing of the blind is fastened to the frame, above or in parallel with the upper guide track.

The invention also relates to a method for arranging a blind of the above described type in connection with a terrace or balcony glazing system, wherein the terrace or balcony glazing system comprises a frame with an upper guide track and a lower guide track as well as glazing elements, wherein at least some of the glazing elements are movable along the upper guide track and the lower guide track. In the method, the blind is fastened to the frame of the terrace or balcony glazing system, separately from the glazing elements.

A preferred embodiment of the method according to the invention comprises, for bringing the blind to a use position, lowering the edge strip downwards, locking the edge strip in parallel with the lower guide track in a removable way, separately from the glazing element, and opening the blind to a desired extent by moving the first and/or second edge profile along the guide cords.

Another preferred embodiment of the method according to the invention comprises, for bringing the blind to a storage position, lifting the edge strip upwards, closer to the lifting means. Preferably, the edge strip is lifted upwards as close to the lifting means as possible so that the screen of the blind takes as little space as possible.

In yet another preferred embodiment of the method according to the invention, the edge strip is lifted and/or lowered manually.

In yet another preferred embodiment of the method according to the invention, the edge strip is lifted and/or lowered by applying an actuator for the lifting means.

The invention has the advantage of making it possible to fasten blinds to such terrace and balcony glazing systems in which the gap between glazing elements stacked side by side is very small.

Furthermore, the invention has the advantage that the screen and the guide cords suspending the screen can be moved completely away from the shielded area when there is no need for a sunshade or a privacy blind. Thus, the blind does not restrict the use of the terrace or the balcony in any way.

### BRIEF DESCRIPTION OF THE DRAWINGS

In the following, the invention will be described in detail. In the description, reference will be made to the appended drawings, in which

FIG. 1a shows, by way of example, a blind according to the invention in a front view, FIG. 1b shows the blind of FIG. 1a in a side view,

FIG. 1c shows the path of the guide cords in the blind shown in FIGS. 1a and 1b,

FIG. 2 shows, by way of example, some lifting means belonging to the blind according to the invention,

FIG. 3a shows, by way of example, a terrace or balcony glazing according to the invention in a front view, and

FIG. 3b shows the terrace or balcony glazing system of FIG. 3a in a cross-sectional view.

### DETAILED DESCRIPTION OF THE INVENTION

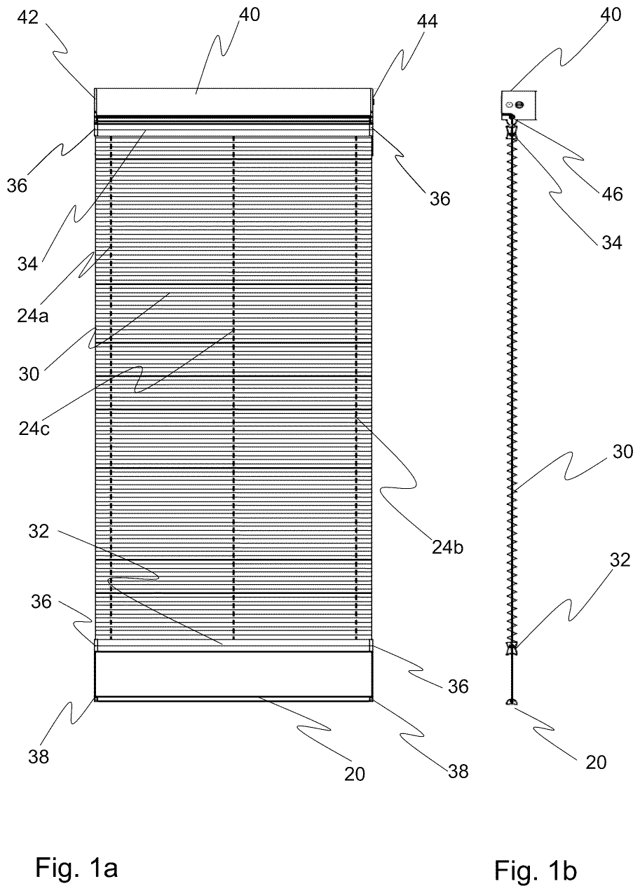

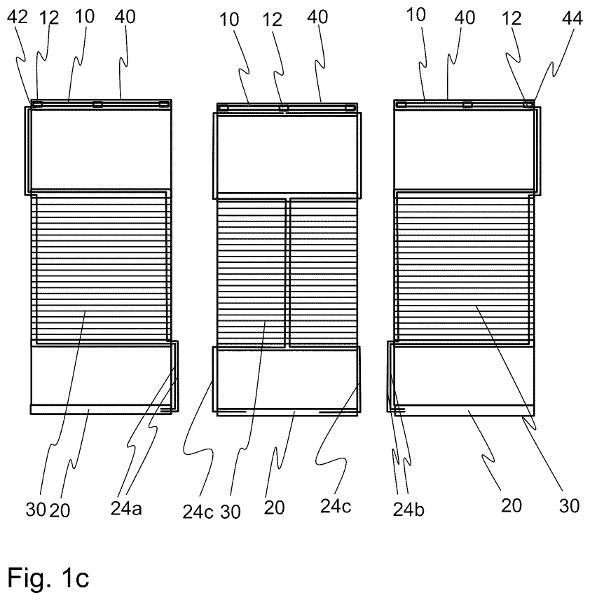

FIG. 1a shows, by way of example, a blind according to the invention in a front view, and FIG. 1b shows the same blind in a side view. In the following, both figures will be described at the same time.

The blind according to the invention comprises a housing 40 at the top edge and an edge strip 20 at the lower edge, as well as three pairs of guide cords 24a, 24b, 24c extending from the edge strip to the inside of the housing. A screen 30 shielding from solar radiation is suspended on the guide cords, to be movable along the guide cords, and is provided with a first edge profile 32 at a first edge and a second edge profile 34 at a second edge. The blind shown in the figure is a so-called pleated blind, wherein the screen is a screen formed of rigid fabric and pleated in a zigzag shape. Suspended on the guide cords, the first and second edge profiles can be moved up and down, irrespective of each other, whereby the surface area covered by the screen changes; in other words, the screen only covers the area between the first and second edge profiles.

The housing 40 of the blind is intended to be fastened to the first edge of the light opening, and the edge profile 32 to the second edge of the light opening, that is, the opposite edge of the light opening, seen from the direction of the first edge. Normally, the housing is fastened to the upper edge of the light opening, and the edge strip is fastened to the lower edge of the light opening. After the installation of the housing and the edge strip, the guide cords are tightened up, after which the edge profiles can be moved along the guide cords. The first edge profile 32 can be moved to come in contact with the edge strip 20, and correspondingly, the second edge profile 34 can be moved to come in contact with the housing 40, whereby the blind covers substantially the whole light opening. Similarly, the first edge profile can be moved to a distance from the edge profile, and/or the second edge profile can be moved to a distance from the housing, whereby an area not covered by the blind is left at the top edge and/or the bottom edge of the light opening.

The housing 40 comprises a trough-like frame part and a cover removably attached to the frame part so that the frame part and the respective cover constitute a rectangular tubular structure with open ends. The housing is provided with a first end piece 42 at its first end and a second end piece 44 at its second end. When installed, the end pieces close the open ends of the housing. Each end piece has a through hole 46 for guide cords 24a, 24b, 24c.

The first and second edge profiles 32, 34 are identical aluminium profiles having a hollow cross-section and provided with a plastic end plug 36 at each end. The end plugs have an end surface transverse to the longitudinal direction of the edge profile and provided with a through hole for guide cords, extending from the end surface to the inside of the edge profile. The edge strip 20 is a tubular or trough-like aluminium profile provided with an edge plug 38 at each end. Like the end plugs, the edge plugs have an end surface transverse to the longitudinal direction of the edge strip and provided with a through hole for guide cords, extending from the end surface to the inside of the edge strip.

In FIG. 1a, the first and second guide cords 24a, 24b extending at the vertical edges of the screen are fastened at their first ends to fastening means inside the edge strip 20. The first and second guide cords exit the edge strip via the holes in the edge plugs 38, turn upwards and enter the first edge profile via the end plugs 36 at the end of the first edge profile. The first and second guide cords exit the first edge strip via holes on its upper side and extend through the pleats of the screen into the second edge profile via holes in its lower surface. The first and second guide cords exit the second edge profile via holes in the end plugs 36 at its ends, turn upwards and enter the housing via holes 46 in the first and second end pieces 42, 44 of the housing 40. The third guide cords 24c in the middle of the screen extend in the edge profiles and the edge strips of the blind in a similar way as the first and second guide cords. Thus, in the area of the screen, the guide cords extend in the vicinity of the vertical edges and in the middle of the screen, but in the area outside the screen they extend substantially in the same straight line as the vertical edges of the screen.

FIG. 1c shows the arrangement of the guide cords in the blind shown in FIGS. 1a and 1b. The blind comprises two first guide cords 24a, two second guide cords 24b, and two third guide cords 24c. For more clarity in the figure, the guide cords are shown in different figures, although in reality all the guide cords are arranged in the same blind. Furthermore, the guide cords which in reality extend partly inside the edge profiles and edge strips are drawn fully visible and separate from the other parts of the blind.

On the left-hand side of FIG. 1c, the figure shows the arrangement of the first guide cords 24a in a blind according to the invention. The first ends of the first guide cords are fixed inside the edge strip 20. The guide cords extend through a hole in the edge plug at the right end of the edge strip, turn upwards and extend through a hole in the end plug at the right end of the first edge profile to the inside of the first edge profile. The first guide cords exit the first edge profile via holes in its upper side so that one first guide cord extends through the pleats in the screen 30 at each edge of the screen. The first guide cords enter the second edge profile through holes in its lower side, and exit the second edge profile through an end plug at its left end. After this, the first guide cords extend in parallel upwards and enter the housing 40 via a hole in the first end piece 42. Inside the housing, a tube 10 is provided that is rotatable around its longitudinal axis and is equipped with a string cone 12 at each end and in the middle. The first guide cords to be introduced in the housing are fastened, at their one end, to the tube or to a string cone at the left end of the tube so that the guide cords are coiled around the string cone when the tube is rotated.

On the right hand side, FIG. 1c shows the arrangement of the second guide cords 24b in a blind according to the invention. The second guide cords are also fastened, at their first ends, to the inside of the edge strip 20. The second guide cords extend through a hole in the edge plug at the left end of the edge strip, turn upwards, and enter the first edge profile through the end plug at the left end of the first edge profile. The second guide cords exit the first edge profile through holes at its upper side so that one second guide cord extends through the pleats of the screen 30 at either edge of the screen. The second guide cords enter the second edge profile through holes at its lower side and exit the second edge profile through an end plug at its right end. After this, the second guide cords extend in parallel upwards and enter the housing 40 through an opening in the second end piece 44. The arrangement of the second guide cords in the blind is thus a mirror image of the arrangement of the first guide cords. The second guide cords to be introduced in the housing are fastened, at their second end, to the tube 10 or to a string cone 12 at the right second end of the tube so that the guide cords are coiled around the string cone when the tube is rotated.

In the middle, FIG. 1c shows the arrangement of third guide cords 23c in a blind according to the invention. The third guide cords are also fastened at their first ends to the inside of the edge strip 20. The third guide cords extend through the end plugs at the end of the edge strip so that one third guide cord exits either plug. Next, the guide cords extend upwards and enter the first edge profile through the end plugs at the ends of the first edge profile. The third guide cords exit the first edge profile through a hole in in the middle section of its upper side and extend in parallel through the pleats of the screen 30, in the middle. The third guide cords enter the second edge profile through a hole in the middle of its lower side, and exit the second edge profile through end plugs at its end, so that one third guide cord exits via either end plug. After this, the third guide cords extend upwards and enter the housing 40 through the opening in the first and second end pieces 42, 44. The third guide cords are fastened at their second ends to the tube 10 or to a string cone 12 in the middle of the length of the tube so that the guide cords are coiled around the string cone when the tube is rotated.

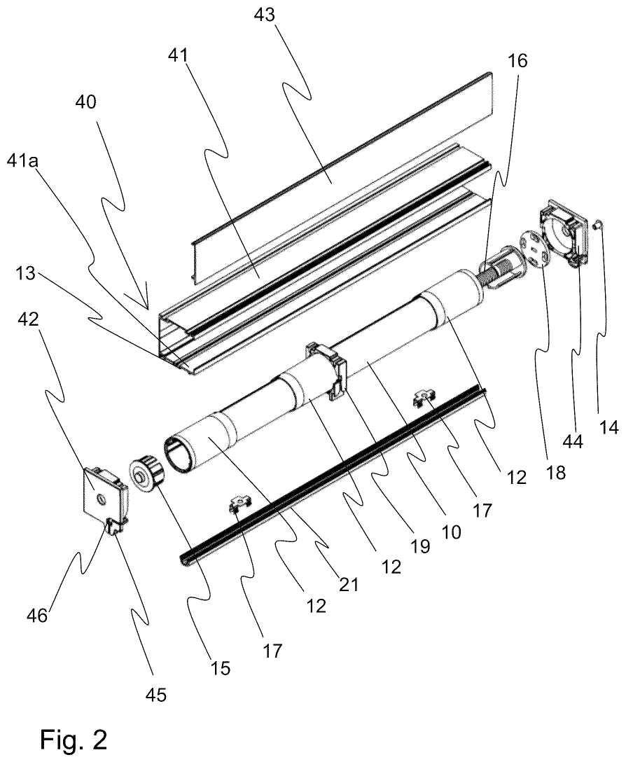

FIG. 2 shows, by way of example, lifting means belonging to the blind according to the invention in a disassembled form, in a so-called exploded view. The lifting means are arranged inside the closed housing 40. The housing comprises a trough-like frame part 41 and a plate-like cover 43 covering the open side of the frame part and connected to the frame part in a detachable way. The cover and the frame part are preferably made of aluminium. The back side of the frame part is preferably provided with elongated protrusions which can be engaged by suitable snap-on supporting means. The first end of the housing is provided with a first end piece 42 closing the end of the housing, and the second end is provided with a second end piece 44. The length of the housing, that is, the distance between the end surfaces of the end piece, is substantially equal to the width of the screen.

The bottom side 41a of the frame part is provided with a groove 13, whose opening has a width smaller than the width of the bottom part of the groove. In alignment with the groove, an upper strip 21 is fastened which has a cross-sectional shape similar to that of the edge strip 20 and to which the first ends of the guide cords are fastened. The upper strip is fastened to the groove of the bottom side by fasteners 17 formed of a thin metal sheet and provided with a flat head and with engaging tongues which turn to an angle from the plane of the head. The fasteners are attached to the groove by inserting the head of the fastener in the groove via the end of the groove. The upper strip is attached to the fasteners by fitting the ends of the engaging tongues in the trough-like upper strip and by pressing the upper strip towards the bottom side, whereby the upper strip engages the fasteners by clicking.

The upper strip 21 is used as a positioning means which guides the second edge profile 34 of the screen to be placed tightly against the upper strip. The upper strip and the second edge profile are provided with magnets, by which the second edge profile tightly engages the upper strip. Thus, no light-transmitting gap is left between the upper strip and the edge profile.

The lifting means comprise a tube 10 whose diameter is preferably 32 mm. The tube may be made of plastic or metal, preferably aluminium. Preferably, plastic string cones 12 are provided around the tube so that one string cone is provided at each end and one in the middle of the tube. On the outer surface of the tube, a groove extends from the first end to the second end of the tube, and the inner surface of each string cone is provided with a protrusion compatible with the groove. The string cones are fastened to the tube in a non-rotatable manner by fitting the string cones around the tube so that their protrusions are received in the groove. The movement of the string cone in the longitudinal direction of the tube is prevented by locking rings not shown in the figure. The number of string cones needed will depend on the number of guide cords for the blind. If the blind is provided with guide cords at the edges of the screen only, that is, there is no guide cord in the middle of the screen, only two string cones are needed for the lifting means. The string cones are thus preferably placed at the ends of the tube. The first end of the tube is provided with a slide bearing 15 which is placed partly inside the first end of the tube. The part of the slide bearing remaining outside the tube is fastened to the first end piece 42 of the housing. An actuator is placed in the second end of the tube, to facilitate rotating the tube around its longitudinal axis. The actuator shown in FIG. 2 is a spring element 16 comprising a helical spring arranged around a metal bar and provided with a suitable preload by rotating the helical spring. The spring element is a device whose structure is known as such and which is commonly used in, e.g., roller blinds. The end of the spring element is fastened by a spring adapter to the inner surface of the second end of the tube in a non-rotatable way. The second end piece 44 comprises a recess in which the second end of the tube and the end of the spring element therein are fitted. A locking plate 18 is provided between the end of the spring element and the bottom of the recess, to prevent free rotation of the spring element after being preloaded. The locking plate is fastened to the spring element by a pin 14 extending through the second end piece 44.

The first and second end pieces are provided with openings 46, through which the guide cords 24a, 24a, 24c are introduced into the housing. The guide cords are fastened at their second ends to the tube 10 or to the string cones 12 around them (the guide cords are not shown in the figure). The opening of the first end piece is designed to guide the first guide cords to coil around the string cone at the first end of the tube. Correspondingly, the opening of the second end piece is designed to guide the second guide cords to coil around the string cone at the second end of the tube. The third guide cords extend through the openings in parallel with the longitudinal axis of the tube 10 towards the string cone in the middle. From the openings, a flexuous channel leads to the edge surface of the end piece, via which channel the guide cord can be inserted in the opening without threading the end of the guide cord through the opening. The shape of the edges of the end pieces 42, 44 substantially corresponds to the cross-sectional shape of the housing, with the exception that the lower edge of the end pieces is provided with an expansion 45 which covers the open ends of the upper strip 21 fastened to the bottom side 41a of the housing.

In the middle of the tube, adjacent to the string cone 12 in the middle, a central bearing 19 is provided whose outer dimensions correspond to the inner dimensions of the housing and which is supported at its edges to the inner surface of the housing. The middle bearing is provided with a central hole, through which the tube 10 extends. The walls of the hole act as slide surfaces when the tube is rotated; in other words, the middle bearing is a slide bearing, by its operating principle. At the edge of the middle bearing abutting the cover 43, cord guides are provided which receive the third guide cords 23c introduced in the housing and guide them to coil around the middle string cone.

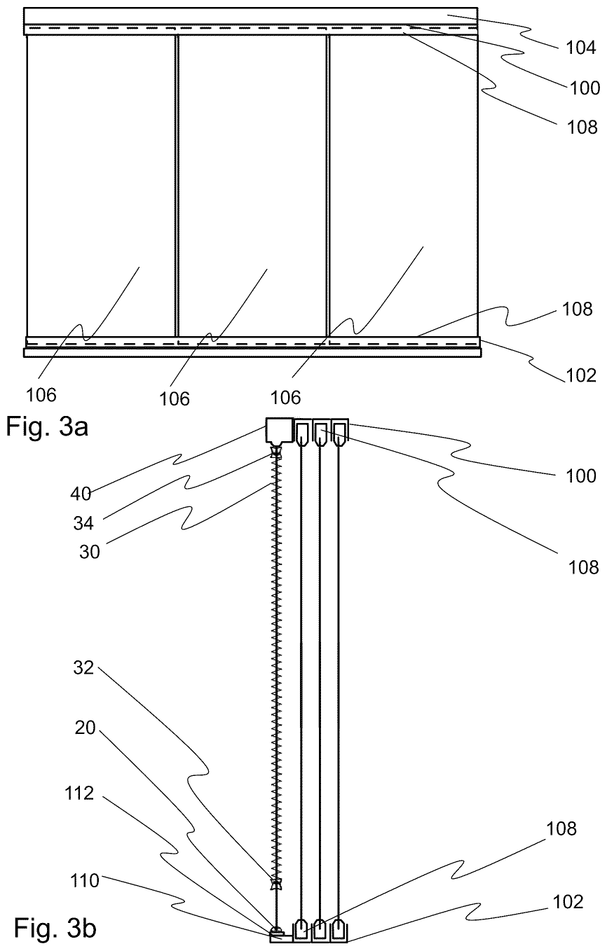

In the assembled and installed blind, the energy loaded in the spring element of the lifting means tends to rotate the tube 10 in a first rotation direction, whereby the guide cords coil around the string cones and the edge strip 20 fastened to the first ends rises upwards. After the edge strip has risen to its uppermost position, the guide cords are substantially coiled up and stored around the string cones in the housing 40. For bringing the blind to a use position, the edge strip is pulled manually downwards, whereby the tube 10 and the string cones around it rotate in a second rotation direction. At the same time, the guide cords stored around the string cones are released and uncoiled from the housing. The edge strip of the uncoiled blind is fastened to the lower edge of the terrace or balcony glazing system in a removable way by suitable fastening means (FIGS. 3a, 3b). When the guide cords are uncoiled from the string cones, spring energy is stored in the spring element, tending to rotate the tube in the first rotation direction and thereby keeping the guide strings tight.

FIG. 3a shows, by way of example, a terrace or balcony glazing system according to the invention in a front view, and FIG. 3b shows the same glazing system in a cross-sectional view. In the following, both figures will be described at the same time.

The terrace or balcony glazing system comprises a frame comprising an upper guide track 100 and a lower guide track 102. The upper guide track and the lower guide track are metal profiles comprising parallel troughs, along which the glazing elements 106 of the glazing system are arranged to move. Typically, three or five troughs are provided, but there may also be a different number of them. The upper and lower guide tracks can be fastened directly to the structures of the building, such as to the floor of a terrace and to the cornice structures of the roof of the terrace, or the frame may also comprise separate pillars and/or beams 104, to which the upper and lower guide tracks are fastened. Preferably, the frame of the glazing system is made of steel or aluminium profiles.

The glazing element 106 comprises a rectangular pane permeable to light and having two parallel vertical side edges and two parallel end edges. Typically, the light-permeable panes used for terrace or balcony glazing systems consist of tempered glass having a thickness of 4 to 6 mm, but a different material and pane thickness is possible as well. The end edges of the light-permeable pane are provided with end profiles 108. The end profiles are aluminium profiles with a glazing groove, in which the end edge of the light-permeable pane is fitted. End pieces of plastic are provided at the ends of the end profiles. The side edges of the light-permeable pane are free edges, that is, edges having no edge profile. The lower end profile of the glazing element is placed in the trough of the lower guide track 102, and the upper end profile is placed in a corresponding trough of the upper guide track 100 so that the glazing element can move in the direction of the guide tracks, supported by the upper and lower guide tracks. The edge profiles of the glazing element are equipped with wheels to facilitate moving of the glazing element.

A number of blinds according to the invention is installed in the terrace or balcony glazing system according to the invention (FIG. 3b). Preferably, the width of the screen 30 of the blind is substantially equal to the width of the glazing element, whereby one opened screen will cover the whole glazing element. The installation of the blinds is implemented so that the housings 40 of the blinds are fastened, at their side surface, to the side surface of the upper guide track 100 on the side of the terrace or balcony. The fastening is made by snap-on fasteners provided with spring-loaded engaging means for engaging protrusions in the housing and in the upper guide track. By means of such fasteners, the housing can be installed without tools. The side surface of the lower guide track 102 facing the terrace is provided with a locking piece 110, and the edge strip 20 of the blind is provided with an engaging part 112 to be connected to the locking piece in a detachable way. The locking piece and the engaging part may comprise parts attaching to each other magnetically, or protrusions or latches attached to each other in a detachable way.

In a terrace or balcony glazing system according to the invention, the entire blind is thus fastened to the frame of the glazing system, completely separately from the glazing elements. The glazing elements can thus be transferred along the upper and lower guide tracks without being obstructed or limited in any way by the blinds. The blinds can be lifted to a storage position by releasing the locking of the edge strip from the lower guide track, wherein the edge strip rises very close to the housing and the guide cords are coiled into the housing. The first and second edge profiles at the edges of the screen rise upwards along with the guide cords coiling up. When the second edge profile 34 hits the housing, it stops from rising. However, the first edge profile 32 continues to rise, whereby the pleating of the screen is increased. When lifted up, the edge strip abuts the first edge profile and the screen is pleated in a tight bundle between the end profiles. At the location of the blind lifted up, a glazing element may be in place, or the glazing element may be moved away from this location.

In the above presented embodiments, the blinds are provided with two first guide cords, two second guide cords, and two third guide cords. The blind according to the invention can be implemented totally without the third guide cords if the width of the blind is not very large. Furthermore, it is feasible that a sufficiently narrow blind may be provided with only one first guide cord and one second guide cord.

In the above presented embodiments, the actuator used for lifting the guide cords was a spring element. Instead of the spring element, the actuator may be an electric motor equipped with a chargeable battery and placed in the tube. The electric motor may be remote controlled, whereby the edge track can be lifted or lowered without manual work steps.

The blind according to the invention is suitable for use not only in terraces or balconies but also indoors. Indoors, the housing of the blind is fastened to a wall above the window or door to be covered, or to the frame of the window or door. A locking piece to which the edge strip of the blind lowered down is fastened to, or close to, the lower frame of the window or door. For a blind to be installed indoors, in particular, the material of the screen may be weakly translucent fabric, whereby the blind lowered down can be used as a blackout blind.

Some advantageous embodiments of the blind, the terrace or balcony glazing system, and the method according to the invention have been described above. The invention is not limited to the solutions described above, but the invention can be implemented in different ways within the scope of the claims.

List of reference numerals:

| | |
|---|---|
| 10 | tube |
| 12 | string cone |
| 13 | groove |
| 14 | pin |
| 15 | slide bearing |
| 16 | spring element |
| 17 | fastener |
| 18 | locking plate |
| 19 | middle bearing |
| 20 | edge strip |
| 21 | upper strip |
| 24a | first guide cord |
| 24b | second guide cord |
| 24c | third guide cord |
| 30 | screen |
| 32 | first edge profile |
| 34 | second edge profile |
| 36 | end plug |
| 38 | edge plug |
| 40 | housing |
| 41 | frame part |
| 41a | bottom side |
| 42 | first end piece |
| 43 | cover |
| 44 | second end piece |
| 45 | expansion |
| 46 | opening |
| 100 | upper guide track |
| 102 | lower guide track |
| 104 | beam |
| 106 | glazing element |
| 108 | end profile |
| 110 | locking piece |
| 112 | engaging part |

1. A blind comprising an edge strip, at least two guide cords connected at their first end to the edge strip, a screen which is movable along the guide cords and whose first edge is provided with a first edge profile and whose second edge is provided with a second edge profile, wherein the guide cords extend through the edge profiles, and wherein the first and second edge profiles are suspended on the guide cords and are movable independently of each other, wherein the blind further comprises lifting means for coiling, uncoiling, and storing the coiled guide cords, wherein the second ends of the guide cords are fastened to the lifting means.

2. The blind according to claim 1, wherein said screen is a pleated piece of fabric.

3. The blind according to claim 1, wherein said lifting means comprise a tube, wherein the tube is rotatable around its longitudinal axis and the second ends of said guide cords are fastened to the tube, directly or indirectly.

4. The blind according to claim 3, wherein string cones are provided around the tube, wherein said guide cords are arranged to coil around said string cones when the tube is rotated.

5. The blind according to claim 3, wherein the blind comprises an actuator for rotating the tube, for example a spring element or an electric motor.

6. The blind according to claim 5, wherein said actuator is arranged at least partly inside the tube.

7. The blind according to claim 1, wherein the blind comprises an elongate housing in which said lifting means are arranged, wherein said housing comprises a first end piece and a second end piece, wherein the end pieces comprise openings facing the housing, and said guide cords are arranged to extend via the opening of the first or the second end piece.

8. The blind according to claim 1, wherein end plugs are provided at the ends of said first and second edge profiles), and wherein the end plugs comprise a hole that opens to the inside of the edge profile, and said guide cords are arranged to extend via the hole in the end plug of the first edge profile and via the hole in the end plug of the second edge profile.

9. The blind according to claim 1, wherein said first edge strip comprises an engaging part for connecting the edge strip in a removable way to the frame of the terrace or balcony glazing system.

10. A terrace or balcony glazing system comprising a frame with an upper guide track and a lower guide track as well as glazing elements, wherein at least some of the glazing elements are movable along the upper guide track and the lower guide track, wherein the system also comprises at least one blind according to claim 1, wherein the blind is fastened to the frame of the glazing system, separately from the glazing elements.

11. The terrace or balcony glazing system according to claim 10, wherein the housing of the blind is fastened to the frame, above or in parallel with the upper guide track.

12. A method for arranging a blind according to claim 1 in connection with a terrace or balcony glazing system, wherein the terrace or balcony glazing system comprises a frame with an upper guide track and a lower guide track as well as glazing elements, wherein at least some of the glazing elements are movable along the upper guide track and the lower guide track, and wherein the method comprises fastening the blind to the frame of the terrace or balcony glazing system, separately from the glazing elements.

13. The method according to claim 12, wherein for bringing the blind to a use position the method comprises
lowering the edge strip downwards,
locking the edge strip in parallel with the lower guide track in a detachable way, separately from the glazing element, and
opening the screen to a desired extent by moving the first and/or second edge profile along the guide cords.

14. The method according to claim 12, wherein for bringing the blind to a storage position, the method comprises lifting the edge strip upwards, closer to the lifting means.

15. The method according to claim 13, wherein in lowering the edge strip is manual or by applying an actuator for the lifting means.

16. The method according to claim 14, wherein lifting the edge strip is manual or by an actuator for the lifting means.
